(19) United States
(12) Patent Application Publication
(10) Pub. No.: US 2025/0025276 A1
(43) Pub. Date: Jan. 23, 2025

(54) SYSTEM FOR ANIMAL DENTAL CLEANING

(71) Applicant: Jaritcely Villanueva Lugo, Fort Wayne, IN (US)

(72) Inventor: Jaritcely Villanueva Lugo, Fort Wayne, IN (US)

(21) Appl. No.: 18/772,169

(22) Filed: Jul. 13, 2024

Related U.S. Application Data
(60) Provisional application No. 63/528,160, filed on Jul. 21, 2023.

(51) Int. Cl. A61D 5/00

(52) U.S. Cl. CPC A61D 5/00

(57) ABSTRACT

A system for animal dental cleaning and treatment comprises a muzzle, a muzzle strap securement assembly, a bite member, a mouthguard assembly, an electrical assembly including a power source, a control panel display touch screen or mobile phone app, and a plurality of blue lights and/or LED lights carried in the bite member and mouthguard assembly and operably connected to the electrical assembly. The system is configured for securement to an animal, and to provide blue light dental care to the animal. The system may be used in a method for cleaning an animal's teeth using blue light. The blue light technology is provided to kill harmful bacteria which cause gingivitis and periodontal disease. The primary harmful bacteria the cleaning system is configured to address is black-pigmented bacteria (BPB), commonly found in animals such as canines and felines. The cleaning system and preventive treatment method help restore the oral biome of the animal to a healthy and balanced state.

### CROSS-REFERENCE TO RELATED APPLICATIONS

The present invention claims the benefits of provisional application 63/528,160 filed on Jul. 21, 2023, confirmation no. 8279.

### FIELD OF THE INVENTION

The present invention relates generally to dental cleaning, and more particularly, to a system for animal dental cleaning.

### BACKGROUND OF THE INVENTION

Dental health for companion animals is an ongoing concern. About 80% of dogs and 70% of cats have some form of periodontal disease by two years of age according to Today's Veterinary Practice. Gingivitis and periodontal disease are the most common conditions needing treatment at companion animal practices. Regular dental care is becoming increasingly recognized as essential.

Many veterinarians use broad spectrum antibiotics in their dental care, but they are running out of effective weapons to counter drug-resistant bacteria. This is exacerbated by pet owners' failures to finish entire prescriptions due to side effects or forgetfulness, which allows surviving bacteria to grow in number and in strength, leading to more resistance.

Typical dental cleaning provided by veterinary offices includes one or more of the following aspects. Your doctor will run the required blood work to make sure your pet is healthy for the cleaning.

Cleaning typically involves scaling, which removes the tartar and plaque buildup near or below the gumline; followed by polishing, which smooths the surface of your pet's teeth and prevents plaque buildup by making it harder to adhere to your pet's teeth. Medications are commonly prescribed to prevent infections and/or pain.

The cost of cleaning dogs' teeth can be anywhere from $150 to $500 depending on your city as well as the age and weight of your dog. The cost of dog dental care has been steadily increasing during the past five years.

The vast majority of pet parents-99%, according to the AVMA—don't brush their dog's teeth, and this is reflected by the persistence of periodontal disease, especially in senior dogs.

Current options include tartar control dental chews, over the counter dog toothbrushes and various other tooth cleaning devices, enzymatic toothpaste for dogs, and additives to put in the dog's drinking water.

For example, options exist which include an oral cleaning tool comprising an illuminated vibrator for oral cleaning tool and an oral cleaning brush head.

Further, options exist which are configured for spacing apart the jaws of an animal, in a fixed relationship during the performance of a medical or dental procedure. The apparatus includes a bit (like a horse bit) member for spacing apart the teeth of an animal, a strap adapted to be wound around the snout of the animal for confining the snout and a strap connector with the strap connector having one end thereof adapted for attachment to the strap and another end for holding the jaws in relatively tight engagement against the bite member after the strap is wound around the snout. This is specifically configured for holding the animal's mouth open for cleaning or other medical procedures.

Options exist which are configured for personal use by humans, such as a hand-held U-shaped tooth plaque detection toothbrush, which comprises a wireless charging base, wherein a detector body is arranged on the wireless charging base, and the top of the detector body is detachably connected with a U-shaped detection toothbrush head; when the toothbrush is used, toothpaste is uniformly coated on the bristles and placed in a mouth, the U-shaped detection toothbrush head is occluded by teeth, detection and tooth brushing can be started by pressing down a key, detection light emitted by the patch type blue light LED irradiates the surface of the teeth, the first fluorescence detection module and the second fluorescence detection module convert light wave signals of the detection light reflected by the surface of the teeth into electric signals containing original image information, the electric signals are transmitted to a main control circuit based on the embedded single chip microcomputer and are wirelessly transmitted to a mobile phone app, a red fluorescence distribution diagram on the teeth is constructed, and a schematic diagram of the tooth surface with dental plaque, related dental plaque distribution parameters and related prompts are given; the vibration motor drives the detection toothbrush head, and the teeth are cleaned by a pasteurization tooth brushing method; the invention has the advantages of reasonable structure, convenient operation, multiple functions, safety and reliability.

Another option available is a personal system for brushing the teeth of a person which appears to include a master input device; a flexible teeth tray configured to at least partially encapsulate one or more of the teeth in a flexible substrate material, the flexible teeth tray comprising one or more vibratory transducers removably coupled to one or more brushing panels; and a controller operatively coupled to the master input device and the one or more vibratory transducers; wherein subject to an input from the master input device, the controller is configured to cause reciprocating brushing motion of the one or more brushing panels against a surface of the one or more encapsulated teeth, to clean the one or more teeth.

Blue light therapy has not previously been considered for canine dental care. However, this has recently become an area of increasing interest. The effectiveness of blue light therapy is becoming more recognized for killing harmful bacteria that cause gingivitis and periodontal disease, helping restore the oral biome to a healthy, balanced state.

Blue light, having a wavelength of 465 nm-470 nm, kills pathogens and is especially powerful for dental conditions in veterinary medicine. Several species of bacteria that cause periodontal disease-known as black-pigmented bacteria (BPB)-transport hemoglobin into their bodies as an iron source (this is thought to be why they make gums bleed, by using enzymes that weaken blood vessels), and store the hemoglobin's dark-colored, photosensitive porphyrin. Light directed at these bacteria is absorbed by the porphyrin and, through a chemical reaction, produces substances that are toxic within the bacterial cell. BPB are common to both canines and humans, as cited in Pigmented-Anaerobic Bacteria Associated with Canine Periodontitis, Hardham J. Dreier K, Wong J, Sfintescu C, Evans RT. Porphyromonas gingivalis, a black-pigmented anaerobic bacteria (BPAB), has been implicated as the primary periopathogen. It has been demonstrated that BPAB are also found in companion animal periodontal pockets. Porphyromonas salivosa, Porphyromonas denticanis (a novel species), and Porphyromonas gulae were found to be the most frequently isolated BPAB associated with canine periodontitis. Further, it is highly unlikely that BPB will develop resistance to blue light.

Blue light with the right wavelengths is shown to produce phototoxicity and oxidative stress selectively to BPB, significantly reducing the load with short duration treatments of 1 to 3 minutes following dental cleaning or other oral interventions.

Blue light therapy is capable of accelerating gum healing, reducing inflammation, promoting circulation, arresting bleeding gums and gum recession, improving bad breath, killing black-pigmented bacteria (BPB), and lessening dependence on drug-resistant drugs, and drugs which cause unwanted side effects. Blue light therapy is best applied on a regular basis depending on severity at time of diagnosis and as a prophylactic to help prevent occurrence and reoccurrence.

No device has been conceived or developed that may be used as a treatment device to promote animal and canine oral healing and health. Current options require invasive procedures to provide sedation and do necessary bloodwork.

Though some veterinary offices have access to blue light, no way has been developed to effectively and conveniently use blue light for animals at home. Ideally, it would be extremely useful to be able to provide a blue light therapy device for use to benefit dogs, cats, or other pets.

Accordingly, there is a need for a solution to at least one of the aforementioned problems. For instance, there is an established need for a blue light treatment device capable of use to benefit pet oral health.

### SUMMARY OF THE INVENTION

The present invention is directed to a system for improved dental cleaning for animals. The system comprises a combination muzzle and mouthguard assembly with a blue light source, configured to be worn by an animal. The system provides blue light dental care with a plurality of LED lights and a blue light source. The muzzle comprises a muzzle body with a strap securement assembly similar to a securement assembly of a conventional muzzle, which is configured to fit on the head and around the snout of an animal. The LED lights and a blue light source are connected to a main control circuit where electric signals are transmitted based on the embedded single chip microcomputer and are wirelessly connected via bluetooth connection to a mobile phone app or control panel. The user may control the operability of the blue lights system via the mobile phone app being operatively coupled with a switch. The system may be battery operated and may further include a battery housing to removably hold a replaceable and/or rechargeable battery which is operably connected to the system. In some embodiments, the system further comprises a light sensor embedded in the bite member, the light sensor being operatively coupled with a switch and being calibrated to activate the blue light source system when a predetermined value is detected.

The system may be configured for any animal. The system may be provided in multiple sizes for use on various animals. In some embodiments, for example, the system may be configured to be worn by and used on a dog. In other embodiments, the system may be configured to be worn by and used on a cat or an equine.

The strap securement assembly is configured like a conventional muzzle so the bite member and the mouthguard assembly will remain in place on the animal for the duration of the treatment and will prevent the animal from removing the system while in use.

In some embodiments, the system may include a mouthguard assembly and muzzle that are U-shaped to accommodate the snout of the animal for treatment with the system.

The mouthguard assembly may be configured for placement outside the animal's snout while the animal's mouth is semi-open, which like the muzzle, may be customized for the animal.

In some embodiments, the bite member is configured with the strap securement assembly and without the mouthguard for the duration of the treatment and will prevent the animal from removing the system while in use.

In some embodiments, the bite member is configured with or without the strap securement assembly and with or without the mouthguard as a standalone system that remains unrestrained in the mouth of the animal for the duration of the treatment with the system.

The system and its components may be provided in multiple sizes for use on various animals. The mouthguard assembly may consist of a food-grade silicone. The mouthguard portions may be fabricated to contain a plurality of blue light sources such as LED lights configured to provide blue light technology for dental treatment.

The system will include an electrical assembly including an electrical compartment configured to removably receive a battery, and a printed circuit board so the battery, the printed circuit board and light sources are operably connected to a system control panel for operation by a user to make sure the treatment is properly administered to the animal.

This system may be battery operated. The battery may be operably connected to a removable charging cord, operably connected to a USB port on the exterior of the muzzle's bite member. The USB port may be located near the control panel and the electrical compartment.

In some embodiments, the system control panel may have a digital display screen with similar controls that may be provided on the mobile phone app. The digital display screen may comprise an LCD display. The system may be programmable and may store various treatment protocols. For example, the system will include a stored protocol to turn on and operate the LEDs for between about 1-3 minutes to provide a treatment with the required intensity.

In addition, the system will provide a counter of treatment sessions executed, which information will be available to the operator, and will be displayed on the mobile phone app and the control panel screen.

In some embodiments, the device will have a small display touch screen on the side of the muzzle. Similarly to the mobile phone app, the purpose of the control panel screen is to allow the user to choose the duration of treatment, the progress of the current treatment session, to activate/deactivate the blue light, and to keep a memory of the number of sessions completed.

The light source is configured to provide visible blue light radiation having a wavelength of between 465-470 nm, a blue light average power of 200 mW, and a blue light pulse repetition frequency of 2 Hz.

The system may provide treatment sessions for animals or pet patients having any suitable duration. In some embodiments, the treatment duration may be from about one minute to about three minutes.

During treatment, the blue light will be emitted by the system in the range of 465 nm-470 nm for about 3 minutes, which is shown to produce phototoxicity and oxidative stress selectively to BPB. This therapy is best applied on a regular basis depending on severity at time of diagnosis and as a prophylactic to help prevent occurrence and recurrence.

The number and duration of the blue light therapy sessions may depend on the severity of the stage of the disease present in the animal. For example, pet patients with early stages of disease such as gingivitis may be treated 2-3 times per week. For the treatment of gingivitis, a small number of sessions may be sufficient. However, in cases of advanced oral and periodontal diseases, additional and long-term maintenance sessions will be required.

The system comprises a bite member, a strap securement assembly similar to a muzzle, a mouthguard, and a source of blue light configured to provide blue light dental care to an animal, such as a dog, a cat or equine. The system is configured for use in a method for cleaning an animal's teeth using blue light. The blue light technology is provided to kill harmful bacteria which cause gingivitis and periodontal disease. The primary harmful bacteria the system is configured to address is black-pigmented bacteria (BPB), commonly found in animals such as canines and felines. The system and treatment method help restore the oral biome of the animal to a healthy and balanced state.

In some embodiments, the blue light will be emitted in the range of 465 nm-470 nm for 3 minutes, which is shown to produce phototoxicity and oxidative stress selectively to BPB. This therapy is best applied on a regular basis depending on severity at time of diagnosis and as a prophylactic to help prevent occurrence and recurrence.

The unprecedented system and method of the present invention provide the following benefits and advantages over previous options. The blue light technology helps accelerate gum healing, reduces inflammation, promotes circulation, improves the condition of bleeding and receding gum tissues, improves bad breath, kills black-pigmented bacteria (BPB), and lessens dependency on drugs which cause antibiotic resistance and unwanted side-effects.

The system and method are versatile and user friendly, being capable of use in a professional setting and for consumer use on pets at home.

The system and method for preventive treatment of the present invention are also beneficial in obviating the necessity of bloodwork and sedation, which require invasive procedures. Placing animals and pets under anesthesia may also subject them to a risk of death. Further, the system and method are cost-effective, and avoid extensive veterinary bills for multiple treatments.

In one aspect, a method may include providing the cleaning system, placing the cleaning system on the animal by placing the muzzle over the animal's snout with the mouthguard assembly covering the teeth and an area to be treated, operating the system by operating the control panel or the mobile phone app to select a stored protocol or to program a custom protocol, actuating the system to turn on and operate the lights or LEDs to for between about 1-3 minutes to provide a treatment to the animal, and removing the system from the animal.

In one aspect, a method of use may include:
providing the system;
placing the muzzle over the animal's snout without the mouthguard add-on to keep the bite member in place;
cleaning the animal's teeth;
administering LED blue light therapy; and
removing the muzzle.

In one aspect, a method of use may include:
providing the system;
detaching the bite member from the muzzle and mouthguard
placing the bite member on the mouth of the animal to keep the mouth open;
brushing and cleaning the animal's teeth manually by a treatment provider; administering LED blue light therapy; and
removing the bite member after the LED blue light treatment is completed.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a perspective view of a cleaning system in accordance with a first illustrative embodiment of the present invention being worn by an animal;

FIG. 2 presents a perspective view of a cleaning system as in FIG. 1 being worn by an animal on which the cleaning system may be used;

FIG. 3 presents a top or bottom view cutaway view showing the mouthguard in the mouth of an animal;

FIG. 4 presents an exploded isometric view of the cleaning system of the present invention;

FIG. 5 presents an isometric view of a mouthguard assembly of the cleaning system of the present invention, enlarged to show detail, and a partial view of a cleaning surface further enlarged to show additional detail;

FIG. 6 presents an exploded isometric view of a control panel display touch screen of the cleaning system;

FIG. 7 presents a schematic view and circuit diagram of the control panel touch screen, the electrical assembly, battery and printed circuit board of the cleaning system;

FIG. 8 presents a flow chart of a method in accordance with the present invention;

FIG. 9 presents a schematic diagram of an exemplary cleaning system in accordance with the present invention; and

FIG. 10 presents a flow chart of an exemplary computing system of the cleaning system in accordance with the present invention.

Like reference numerals refer to like parts throughout the several views of the drawings.

### DETAILED DESCRIPTION

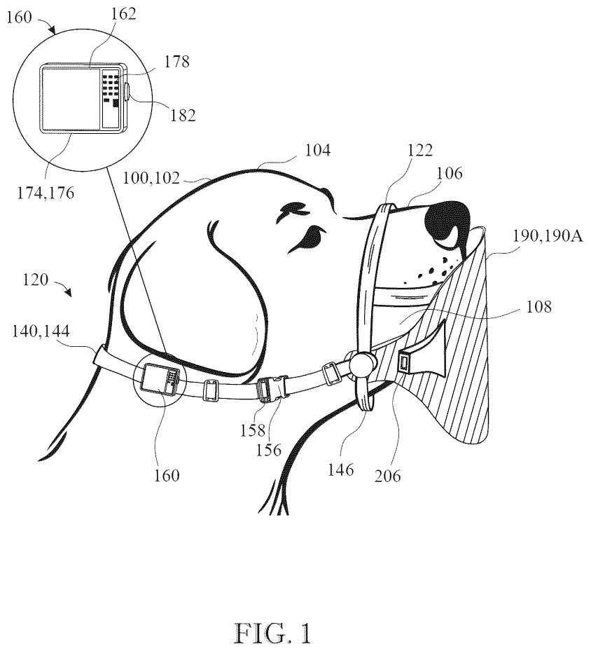

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary of the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed to a cleaning system for improved dental cleaning and dental treatment for an animal, hereinafter the cleaning system 120.

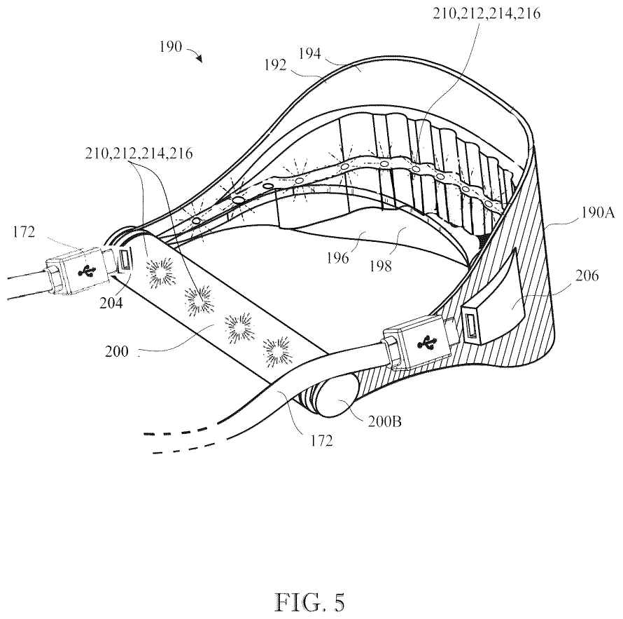

Referring to FIGS. 1-7, in a first implementation of the invention, the cleaning system 120 comprises a combination muzzle 122 and mouthguard assembly 190 with a blue light source 200, configured to be worn by an animal 100. The system provides blue light dental care with a blue light source 210, which may comprise an LED light source 214 (best seen at FIG. 5). The blue light source 210 may comprise a plurality of blue lights 212. The LED light source 214 may comprise a plurality of LED lights 216.

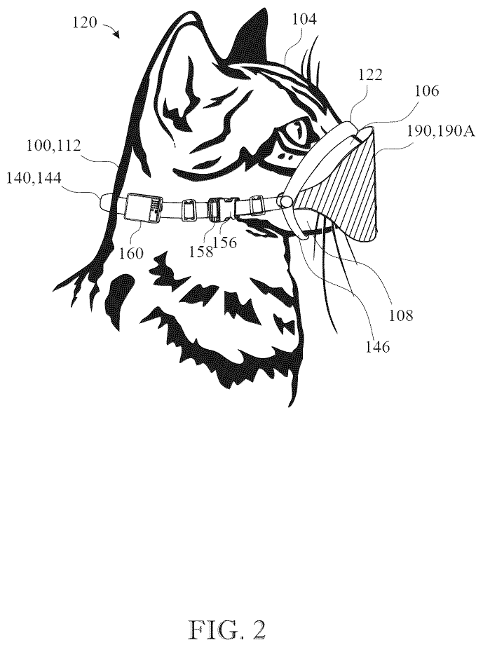

The cleaning system 120 may be configured for any animal 100. The cleaning system 120 may be provided in multiple sizes for use on various animals. In some embodiments, for example, the cleaning system 120 may be configured to be worn by and used on a dog 102, as seen at FIG. 1. In other embodiments, the cleaning system 120 may be configured to be worn by and used on a cat 112, as shown at FIG. 2. In some embodiments, the cleaning system 120 may be configured to be used for any pet animal, large or small such as an equine.

As shown at FIG. 1, the muzzle 122 comprises a muzzle strap securement assembly 140. The muzzle strap securement assembly 140 comprises a neck strap 144, and a jaw strap 146. The straps of the muzzle strap securement assembly 140 may be adjustable.

The muzzle strap securement assembly may include a strap closure assembly 156. The strap closure assembly may be any suitable closure device, such as, for example without limitation, a buckle closure, a hook and loop closure, hooks, buttons, or snaps. In some embodiments, the strap closure assembly may comprise at least one buckle 158.

The muzzle strap securement assembly 140 is configured to fit on the head 104 and around the snout 106 of an animal 100 in a manner similar to a conventional muzzle. The strap securement assembly 140 is configured to retain the system 120, the bite member 200 and the mouthguard assembly 190 will remain in place on the animal 100 for the duration of the treatment and will prevent the animal 100 from removing the cleaning system 120 while in use.

The muzzle and its components may be made of any suitable materials, such as, for example without limitation, plastic materials, neoprene, woven and nonwoven fabrics, or the like.

Referring to FIGS. 1, 2, 4 and 6, a control panel display touch screen 174 is provided on the muzzle strap assembly 140. The control panel display touch screen 174 is operably connected to the plurality of blue lights and LED lights 212,216 so a user may operate the cleaning system 120.

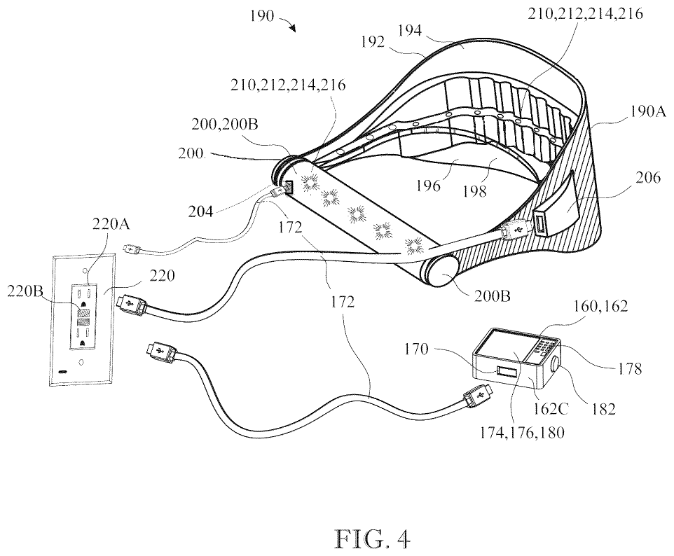

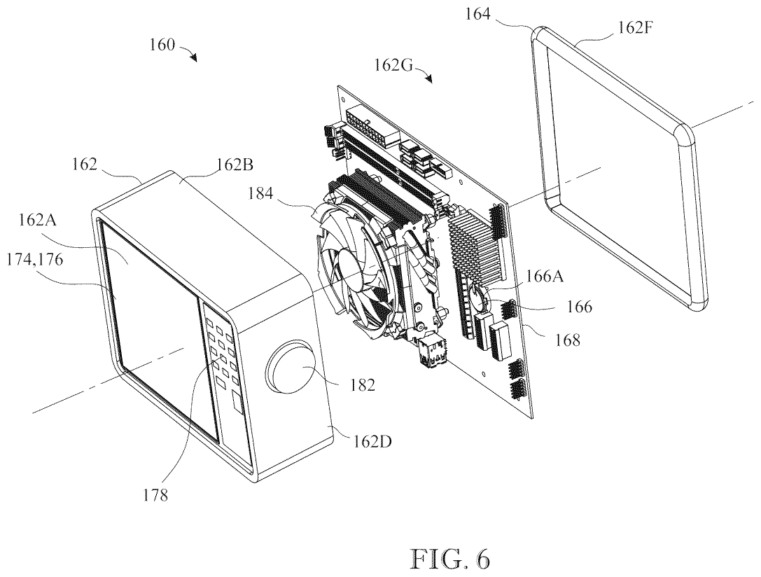

With reference to FIGS. 4 and 6, the cleaning system 120 comprises an electrical assembly 160 including a power source. The power source may comprise a battery 166 which may be rechargeable. The power source may comprise a power or charging cord 172 as shown at FIG. 4, which may be a charging cord, an AC power cord, or combinations thereof. The cord 172 may be connectable to an AC power source such as an electrical outlet 220 as seen at FIG. 4. The power cord may be configured to be plugged into any suitable power cord receptacle, non limiting examples of which may include 2-prong, 3-prong, USB, micro USB, or the like. As shown at FIG. 4, the electrical outlet 220 may comprise a conventional power outlet with at least one three prong receptacle 220A and at least one USB receptacle 220B.

The cleaning system 120 may be battery operated and may further include an electrical and battery compartment 162 or 200 which may be rechargeable, and a compartment door 164 or 200B. The power source may comprise a power or charging cord 172 as shown at FIG. 4, which may be a charging cord, an AC power cord, or combinations thereof. The cord 172 may be connectable to an AC power source such as an electrical outlet 220 as seen at FIG. 4. The power cord may be configured to be plugged into any suitable power cord receptacle, non limiting examples of which may include 2-prong, 3-prong, USB, micro USB, or the like. As shown at FIG. 4, the electrical outlet 220 may comprise a conventional power outlet with at least one three prong receptacle 220A and at least one USB receptacle 220B.

In some embodiments, the 162 electrical and battery compartment has a compartment front 162A, a compartment top 162B, a compartment bottom 162C, a compartment right side 162D, a compartment left side 162E, a compartment rear 162F, and a compartment interior defined by the compartment front, top, bottom, right side, left side and rear 162A-F, and the compartment door 164 is at the compartment rear 162F.

The electrical and battery compartment 162 is configured to removably hold a replaceable and/or rechargeable battery 166 which is operably connected to the control panel display touch screen 174 of the cleaning system 120.

In some embodiments, the electrical and battery compartment is configured inside the bite member 200 that holds a removable, replaceable, and/or rechargeable battery 202 that can be accessed from compartment door 200B; and operably connected to the control panel display touch screen 174 or mobile phone app of the cleaning system 120 that are configured to operate while the cleaning assembly is in use.

The control panel display touch screen 174 may include a digital display 176, a keypad 178 and a timer and timer display 180.

The electrical compartment 162 is configured to support a printed circuit board 168. In some embodiments, as shown at FIG. 4, the printed circuit board 168 may include a battery holder 166A configured to hold a replaceable battery 166. The battery may be a rechargeable battery capable of being connected to and recharged by the AC power source. The battery 166 may be any suitable battery, and is shown as a button battery supported in the battery holder 166A located on the printed circuit board 168. In some embodiments, the compartment 160 includes a fan 184 located on the printed circuit board 168 configured to operate while the cleaning assembly is in use.

The cleaning system may include a power cord and/or charging cord receptacle 170, and a power cord or charging cord 172. The battery 166 is operably connected to a compartment receptacle 170 configured to receive and connect to a power cord and/or charging cord 172. The power cord or charging cord 172 may be configured to be plugged into the receptacle 170.

The compartment receptacle 170 may be located anywhere on the compartment 162, but is shown at the compartment bottom 162C.

The control panel display touch screen 174 may include a digital display 176, a keypad 178 and a timer and timer display 180. The control panel display touch screen 174 and digital display 176 may be located at the compartment front 162A. The keypad 178 and a timer display 180 may also be located at the compartment front 162A. The timer display 180 may be incorporated into the touch screen 174 and digital display 176.

A power button 182 is located on compartment 162. Though the power button may be provided at any suitable location, the power button 182 is located at the compartment right side 162D.

The control panel display touch screen 174, the timer and timer display 180, and the plurality of lights 212,216 are operably connected to the power source. For example, the battery 166, the printed circuit board 168 and light sources 210,214 including a plurality of blue lights 212 and a plurality of LEDs 216 are operably connected to the system control panel display touch screen 174 for operation by a user to make sure the treatment is properly administered to the animal 100.

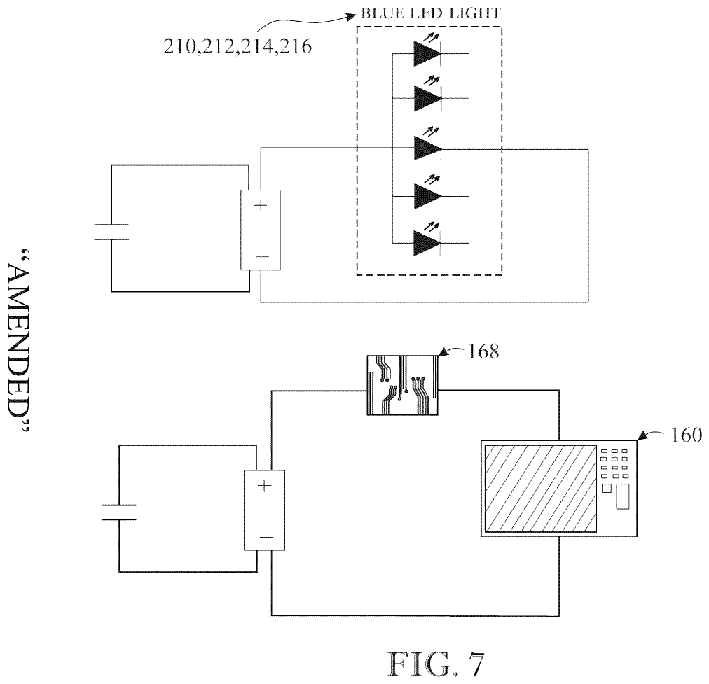

The power button or switch 182 is operably connected to the control panel display touch screen 174, the light source and the power source. The power button or switch 182 may be actuated by a user to power on the cleaning system 120. The timer and timer display 180 are operably connected to the power button or switch 182, so that after a user powers on the cleaning system 120 by actuating the power button or switch 182, the plurality of blue lights 212 or LEDs 216 may be operated for a predetermined length of time sufficient for the treatment to be implemented, and then automatically power off after the treatment is concluded. FIG. 7 shows a circuit diagram which shows the connection between the electrical components of the cleaning apparatus.

The power button or switch 182, and the timer and timer display 180 may be accessible by the control panel display touch screen 174, which may be located at any suitable location of the cleaning system 120.

In some embodiments, a power button 203 or switch being operatively coupled with light sensors 201 may be located at any suitable location of the bite member 200 and accessible from the electrical components located in 200B.

The system control panel display touch screen 174 may have a digital display 176. The digital display 176 may comprise an LCD display 176A. The cleaning system 120 may be programmable and may store various treatment protocols. For example, the cleaning system 120 will include a stored protocol to turn on and operate the LEDs for between about 1-3 minutes to provide a treatment with the required intensity. The timer and timer display 180 may be capable of being operated to enter or select a specific treatment program or select from a plurality of present treatment programs.

In addition, the cleaning system 120 may be configured to provide a counter of treatment sessions executed, which information will be available to the operator, and will be displayed on the control panel display touch screen 174. The purpose of the control panel display touch screen 174 is to allow the user to choose the duration of treatment, the progress of the current treatment session, to activate/deactivate the blue light, and to keep a memory of the number of sessions completed.

Referring now to FIGS. 4 and 5, the mouthguard assembly 190 may have a mouthguard exterior surface 190A. The mouthguard assembly may comprise an upper mouthguard portion 192 and a lower mouthguard portion 196 configured for placement in an animal's mouth 108. Like the muzzle 122, the components of the mouthguard assembly 190 may be customized for the animal 100. In some embodiments, the cleaning system 120 may include a mouthguard assembly 190 that is U-shaped to accommodate the teeth 110 of the animal 100 for treatment with the cleaning system 120.

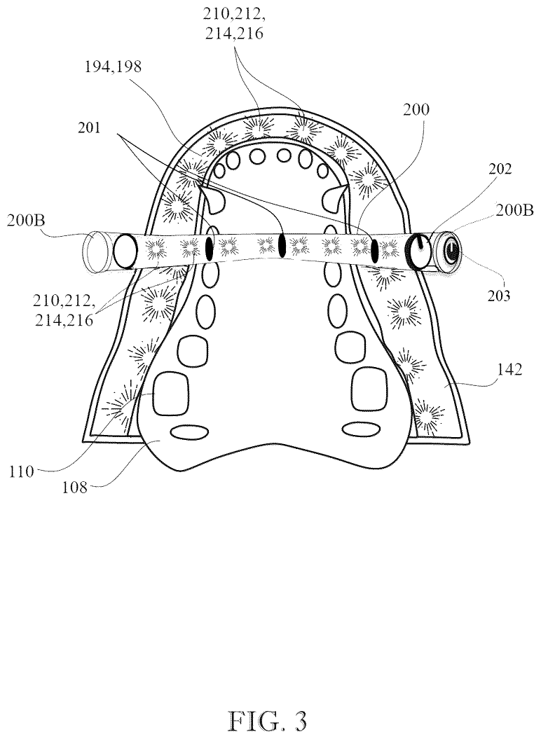

The mouthguard assembly 190 is configured to fit over the teeth 108 of the animal 100. The mouthguard assembly may comprise an upper mouthguard portion 192 having an upper mouthguard interior surface 194 configured to cover the upper area of the animal's snout 100. The lower mouthguard portion 196 has a lower mouthguard interior surface 198 configured to cover the lower area of the animal's snout 100. FIG. 3 shows the manner in which the mouthguard may fit over the teeth area 108. FIG. 3 also shows the mouthguard 190 configured with the bite member 200 to retain the mouth guard assembly 190 in place for treatment of the animal 100.

A mouthguard power receptacle 206 is provided at the exterior surface 196 of the mouthguard assembly 190, which is capable of receiving a power cord 172 to operably connect the mouthguard assembly with the electrical assembly 160 for operation of the cleaning system 120.

A bite member power receptacle 204 is provided at the exterior surface of the bite member assembly 200, which is capable of receiving a power cord 172 to operably connect the bite member with the electrical assembly 160 for operation of the cleaning system 120.

The mouthguard assembly 190 and its components 192,196 may be made of food-grade silicone.

The upper and lower mouth guard portions 192,196 may be fabricated to contain a blue light source 210 which may be a plurality of blue lights 212 or a plurality of LEDs 216 configured to provide blue light technology for dental treatment. The blue light source 210 is configured to provide visible blue light radiation having a wavelength of between 465-470 nm, a blue light average power of 200 mW, and a blue light pulse repetition frequency of 2 Hz.

The cleaning system 120 and its components may be made of any suitable material by any suitable fabrication process and may have any suitable dimensions. The cleaning system 120 and its components may be provided in multiple sizes for use on various animals. In some embodiments, at least a portion of the cleaning system 120 may be integrally molded. In some embodiments, the mouthguard assembly 190 may be integrally molded. In some embodiments, the cleaning system 120 may comprise assembled components. Some components may be fabricated by 3D printing or additive manufacturing.

The cleaning system 120 may be used to provide treatment sessions for an animal 100 or pet patient having any suitable duration. In some embodiments, the treatment duration may be from about one minute to about three minutes.

During treatment, the blue light will be emitted by the cleaning system 120 in the range of 465 nm-470 nm for 3 minutes, which is shown to produce phototoxicity and oxidative stress selectively to BPB. This therapy is best applied on a regular basis depending on severity at time of diagnosis and as a prophylactic to help prevent occurrence and recurrence.

The number and duration of the blue light therapy sessions may depend on the severity of the stage of the disease present in the animal 100. For example, pet patients with early stages of disease such as gingivitis may be treated 2-3 times per week. For the treatment of gingivitis, a small number of sessions may be sufficient. However, in cases of advanced oral and periodontal diseases, additional and long-term maintenance sessions will be required.

In some embodiments, the blue light will be emitted in the range of 465 nm-470 nm for 3 minutes, which is shown to produce phototoxicity and oxidative stress selectively to BPB. This therapy is best applied on a regular basis depending on severity at time of diagnosis and as a prophylactic to help prevent occurrence and recurrence.

The system for animal dental cleaning may comprise:
a muzzle with a muzzle strap securement assembly configured for securement of the system to a head of an animal with the muzzle over a snout of the animal;
an electrical assembly including a power source and a control panel display touch screen configured to enable a user to operate the system by interaction with the control panel display touch screen;
a mouthguard assembly being located in and supported by the muzzle;
a plurality of lights carried in mouthguard assembly which are operably connected to the electrical assembly, the plurality of lights comprising a plurality of blue lights, a plurality of LED lights and combinations thereof;

When the system is secured to the head of the animal, the mouthguard assembly is configured to cover an animal's set of teeth. When a user operates the system by interacting with the control display panel touch screen, the user may to select a stored cleaning or treatment protocol or may program the cleaning system to perform a custom cleaning or treatment protocol and may activate the cleaning system by turning on the plurality of lights for between about 1-3 minutes to provide an LED light cleaning or treatment to the animal.

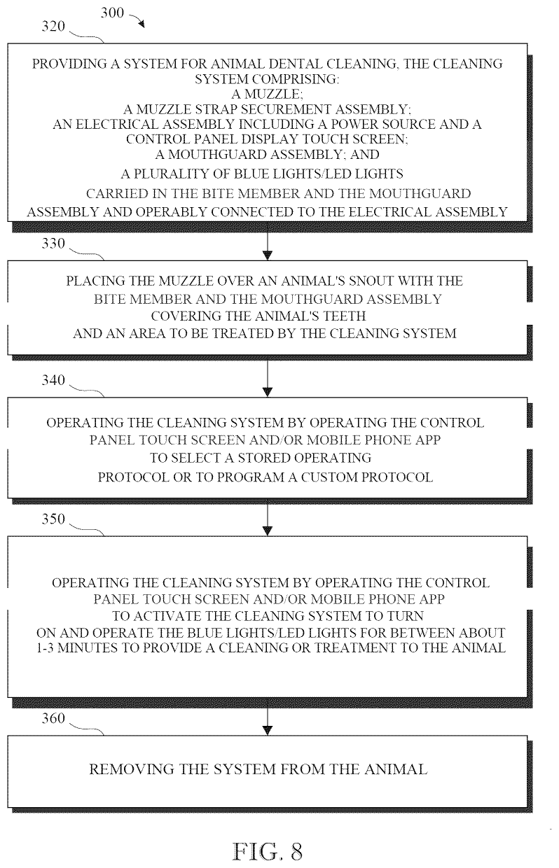

Referring to FIG. 8, a method 800 of use of the cleaning system 120 may include providing the cleaning system 120, placing the muzzle 122 over the animal's snout 106 to keep the mouth 108 open, brushing and cleaning the animal's teeth 110 and removing the muzzle 122.

In one aspect, a method may include providing the cleaning system 120, placing the muzzle 122 over the animal's snout 106 with the mouthguard assembly 190 components covering the animal's teeth 110 and an area to be treated, operating the cleaning system 120 by operating the control panel display touch screen 174 to select a stored protocol or to program a custom protocol, actuating the cleaning system 120 to turn on and operate the LEDs to for between about 1-3 minutes to provide a treatment to the animal 100, and removing the cleaning system 120 from the animal 100.

In one aspect, a method may include providing the cleaning system 120, placing the muzzle 122 over the animal's snout 106 with the mouthguard assembly 190 components covering the animal's teeth 110 and an area to be treated, operating the cleaning system 120 by operating the mobile phone app to select a stored protocol or to program a custom protocol, actuating the cleaning system 120 to turn on and operate the LEDs to for between about 1-3 minutes to provide a treatment to the animal 100, and removing the cleaning system 120 from the animal 100.

The present invention may provide a method for using the cleaning system 120. The method may comprise one or more of the following steps and combinations thereof:
providing the cleaning system;
placing the muzzle over the animal's snout to keep the mouth open and/or keep the mouthguard in place;
cleaning the animal's teeth;
administering LED blue light therapy; and
removing the muzzle.

In some embodiments, the method of use may comprise:
providing the system;
placing the muzzle over the animal's snout to keep the mouth open;
brushing and cleaning the animal's teeth manually by a treatment provider;
administering LED blue light therapy; and
removing the muzzle after the LED blue light treatment is completed.

In some embodiments, the method of use may comprise:
providing the cleaning system;
placing the muzzle over the animal's snout with the bite member to keep animal's mouth open;
brushing and cleaning the animal's teeth manually by a treatment provider;
administering LED blue light therapy; and
removing the muzzle after the LED blue light treatment is completed.

Referring now to FIG. 8, a method 300 for using the cleaning system 120 may include the following steps:
(320) providing a system for animal dental cleaning, the cleaning system comprising: a muzzle;
a muzzle strap securement assembly;
an electrical assembly including a power source, a control panel display touch screen and a mobile phone app in some embodiments;
a mouthguard assembly; and
a plurality of blue lights/led lights carried in the bite member and in the mouthguard assembly and operably connected to the electrical assembly;
(330) placing the muzzle over an animal's snout with the bite member and the mouthguard assembly covering the animal's teeth and an area to be treated by the cleaning system;
(340) operating the cleaning system by operating the control panel touch screen or the mobile phone app to select a stored operating protocol or to program a custom protocol;
(350) operating the cleaning system by operating the control panel touch screen or mobile phone app to activate the cleaning system to turn on and operate the blue lights/led lights for between about 1-3 minutes to provide a cleaning or treatment to the animal; and
(360) removing the system from the animal.

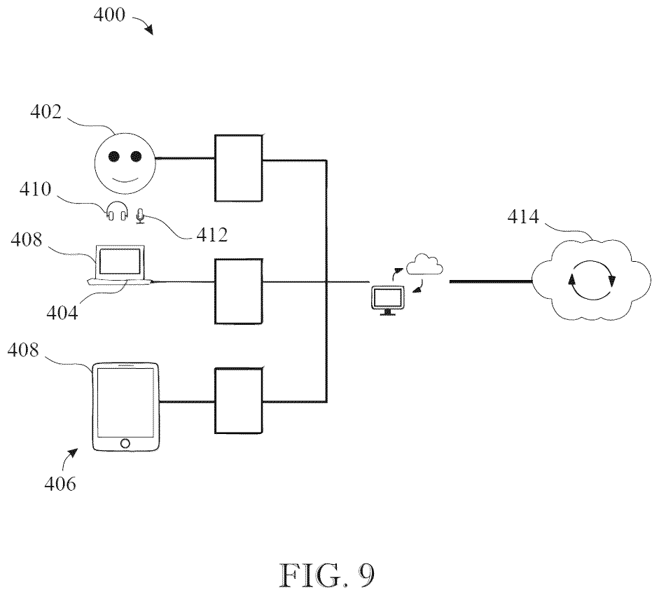

Referring now to FIG. 9, a schematic diagram of an exemplary operating system 400 for operating the cleaning system 120 is shown. The operating system 400 may be used by at least one end-user 402, who may be a veterinary professional or a consumer/pet parent. The operating system 400 may comprise a computing device 404 in which a cleaning system software program 408 is installed (the computing device 404 is shown as a desktop or a notebook computer). The system software program 408 may be used to operate the cleaning system 120. It can be seen that the operating system 400 may be connected to the cleaning system 120 by a wired or wireless connection. The operating system 400 may include a mobile computing system 406 (in which the software program 408 is installed). In some embodiments, the system may further comprise an administrative system 414 to which the computing devices 404,406 may wirelessly (or by wired connection) communicate through use of the software program 408. The computing device 404,406 may comprise any suitable device, non limiting examples of which may be an end-user's mobile phone or tablet. The end user 402 may use a headphone device 410 and a microphone 412 which may be operatively connected to the computing device 404,406.

In some embodiments the method or methods described herein may be executed or carried out by a computing system including a tangible computer-readable storage medium, also described herein as a storage machine, that holds machine-readable instructions executable by a logic machine (i.e. a processor or programmable control device) to provide, implement, perform, and/or enact the methods, processes and/or tasks described herein. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI), or any visual element of the methods or processes described herein. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that a certain task is to be executed by the computing system, such as requesting the computing system to display any of the above-described information or requesting that the user input updates or modifies existing stored information for processing. A communication subsystem may allow the methods described herein to be executed or provided over a computer network. For example, the communication subsystem may be configured to enable the computing system to communicate with a plurality of personal computing devices. The communication subsystem may include wired and/or wireless/bluetooth communication devices to facilitate networked communication. The described methods or processes may be executed, provided, or implemented for a user or one or more computing devices via a computer-program product such as via an application programming interface (API).

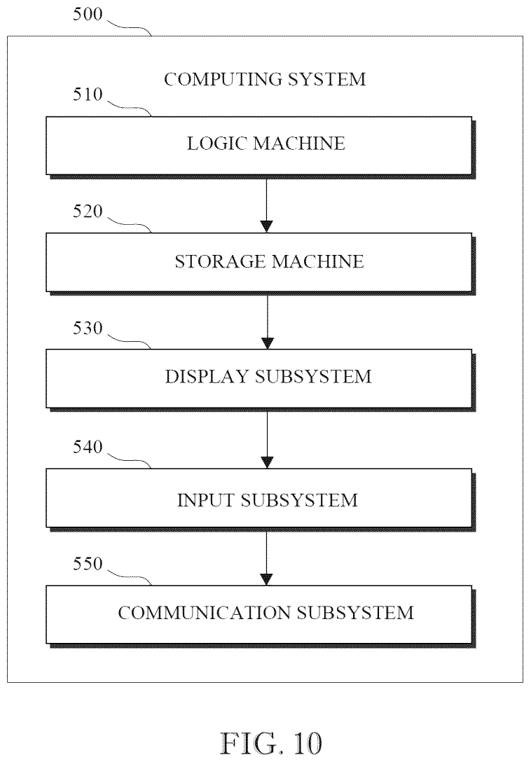

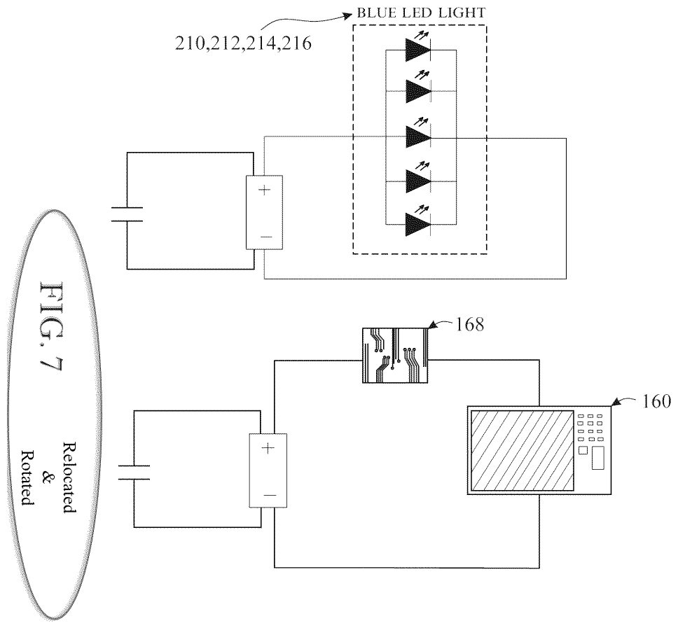

Referring now to FIG. 10, the illustration of FIG. 10 schematically presents an embodiment of a computing system 500 that may represent a computing system of the cleaning system in accordance with an embodiment of the present invention. In some embodiments the methods described herein may be executed on a computing system such as the computing system 500 of FIG. 10. For example, the storage machine 520 may hold instructions executable by the logic machine 510 to provide the method to users. Display subsystem 530 may display the various elements of the method to a system end-user. For example, the display subsystem 530, the storage machine 520, and the logic machine 510 may be integrated such that the method may be executed while being displayed on a display screen. The input subsystem 540 may receive user input from an end-user to indicate the various choices or user inputs described herein. The described method may be executed, provided, or implemented to a user on one or more computing devices via a computer-program product such as via an application programming interface (API). FIG. 10 schematically shows a non-limiting exemplary embodiment of a computing system 500 that can enact the method described herein. Computing system 500 may be any appropriate computing device such as a personal computer, tablet computing device, gaming device or console, mobile computing device, etc. Computing system 500 includes a logic machine 510 and a storage machine 520. Computing system 500 may include a display subsystem 530, input subsystem 540, and communication subsystem 550. Logic machine 510 may execute machine-readable instructions via one or more physical devices. For example, the logic machine 510 may be configured to execute instructions to perform tasks for a computer program. The logic machine 510 may include one or more processors to execute machine-readable instructions. The storage machine 520 includes one or more physical devices configured to hold or store instructions executable by the logic machine 510 to implement the method. When such methods and processes are implemented, the state of storage machine 520 may be changed to hold different data. For example, the storage machine 520 may include memory devices such as various hard disk drives or CD or DVD devices. The display subsystem 530 may visually present data stored on the storage machine 520. For example, the display subsystem 530 may visually present data to form a graphical user interface (GUI). The input subsystem 540 may be configured to connect and receive input from devices such as a mouse, keyboard, or gaming controller. The communication subsystem 550 may be configured to enable the computing system 500 to communicate with other computing devices. The communication subsystem 550 may include wired and/or wireless communication devices to facilitate networked communication.

The unprecedented cleaning system and method of the present invention provide the following benefits and advantages over previous options. The blue light technology helps accelerate gum healing, reduces inflammation, promotes circulation, improves the condition of bleeding and receding gum tissues, improves bad breath, kills black-pigmented bacteria (BPB), and lessens dependency on drugs which cause antibiotic resistance and unwanted side-effects.

The cleaning system and method are versatile, user friendly, and capable of use in a professional setting or for consumer use on pets at home.

The cleaning system and preventive method of the present invention are also beneficial in obviating the necessity of bloodwork and sedation, which require invasive procedures. Placing animals and pets under anesthesia may also subject them to a risk of death. Further, the cleaning system and method are cost-effective, and avoid extensive veterinary bills for multiple treatments.

In summary, the cleaning system for animal dental cleaning comprises a muzzle; a muzzle strap securement assembly; a bite member; an electrical assembly including a power source and a control panel display touch screen configured to enable a user to operate the system by interaction with the control panel display touch screen; a mouthguard assembly being located in and supported by the muzzle; and a plurality of lights comprising a plurality of blue lights, a plurality of LED lights and combinations thereof. The muzzle strap securement assembly is configured for securement of the system to a head of an animal with the muzzle over a snout of the animal. When the system is secured to the head of the animal, the plurality of lights is carried in the bite member and the mouthguard assembly, and the plurality of lights is operably connected to the electrical assembly. When a user operates the system by interacting with the control display panel touch screen or the mobile phone app, the user may select a stored cleaning or treatment protocol or may program the cleaning system to perform a custom cleaning or treatment protocol and may activate the cleaning system to turn on and operate the plurality of lights for between about 1-3 minutes to provide a cleaning or treatment to the animal.

The system is configured to provide blue light dental care to an animal. The cleaning system is configured for use in a method for cleaning an animal's teeth using blue light. The blue light technology is provided to kill harmful bacteria which cause gingivitis and periodontal disease. The primary harmful bacteria the cleaning system is configured to address is black-pigmented bacteria (BPB), commonly found in animals such as canines and felines. The cleaning system and treatment method help restore the oral biome of the animal to a healthy and balanced state.

A system for animal dental cleaning may comprise:
a muzzle;
a muzzle strap securement assembly;
a bite member
an electrical assembly including a power source and a control panel display touch screen or mobile phone app configured to enable a user to operate the system by interaction with the control panel display touch screen or mobile phone app;
a mouthguard assembly
the mouthguard assembly being located in and supported by the muzzle; and
a plurality of lights comprising a plurality of blue lights, a plurality of LED lights and combinations thereof;
wherein the muzzle strap securement assembly is configured for securement of the system to a head of an animal with the muzzle over a snout of the animal;
wherein when the system is secured to the head of the animal,
wherein the plurality of lights is carried in the bite member and the mouthguard assembly;
wherein the plurality of lights is operably connected to the electrical assembly; and
wherein when a user operates the system by interacting with the control display panel touch screen or the mobile phone app, the user may to select a stored cleaning or treatment protocol or may program the cleaning system to perform a custom cleaning or treatment protocol and may activate the cleaning system to turn on and operate the plurality of lights for between about 1-3 minutes to provide an LED light cleaning or treatment to the animal.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1: A system for animal dental cleaning, the system comprising:
a muzzle;
a muzzle strap securement assembly;
a bite member assembly;
a mouthguard assembly being located in and supported by the muzzle;

2: A system for animal dental cleaning, as in claim 1 further comprising:
a bite member that may be configured independently from the muzzle strap assembly or the mouthguard assembly as a standalone system that remains unrestrained in the mouth of the animal for the duration of the treatment with the system;
an electrical assembly including a power source that may be configured to enable a user to operate the system by interaction with the control panel display touch screen or mobile phone app;
a plurality of lights comprising a plurality of blue lights, a plurality of LED lights and combinations thereof;
wherein the muzzle strap securement assembly is configured for securement of the system to a head of an animal with the muzzle over a snout of the animal;
wherein when the system is secured to the head of the animal,
wherein the plurality of lights is carried in the bite member and the mouthguard assembly;
wherein the plurality of lights is operably connected to the electrical assembly; coupled with light sensors and wherein when a user operates the system by interacting with the control display panel touch screen or mobile phone app, the user may to select a stored cleaning or treatment protocol or may program the cleaning system to perform a custom cleaning or treatment protocol and may activate the cleaning system to turn on and operate the plurality of lights for between about 1-3 minutes to provide an LED light cleaning or treatment to the animal.
